(19) United States
(12) Patent Application Publication
(10) Pub. No.: US 2005/0058548 A1
(43) Pub. Date: Mar. 17, 2005

(54) Method of controlling fluid flow

(75) Inventors: Edward Thomas, Yardville, NJ (US); Joseph Demarco, Newtown, PA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: U.S. Filter/Stranco Products, Bradley, IL (US)

(21) Appl. No.: 10/661,447

(22) Filed: Sep. 11, 2003

(51) Int. Cl. F04B 49/00; B32B 9/00

(52) U.S. Cl. 417/43

(57) ABSTRACT

According to various aspects of embodiments of the invention, the actual flow rate produced by a metering pump is continuously measured using a positive displacement flow meter. Based on the flow rate reported by the meter, the output of the metering pump is continuously adjusted via a pump controller to achieve a desired set point flow rate. The operator sets a desired flow rate, rather than setting the pump cycle rate, or the output rating per pump cycle to produce an approximate output flow rate. According to some embodiments of aspects of the invention, a fluid feed system commanded to a fluid flow rate set point by a set point signal includes: a metering pump receiving a control signal directing a cycle rate for the metering pump; a fluid flow meter connected to measure a fluid flow rate produced by the metering pump and which provides a fluid flow rate signal; and a metering pump controller responsive to the set point signal and the fluid flow rate signal to adjust the control signal to direct a cycle rate which produces a fluid flow rate equal to the fluid flow rate set point. According to other embodiments of aspects of the invention, there is a method of controlling a fluid flow rate, comprising: displacing an approximately defined quantity of fluid at a rate determined by a control signal; measuring an actual flow rate; and adjusting the control signal to produce a rate of displacing the approximately defined quantity of fluid such that the actual flow rate matches a desired flow rate. According to yet other embodiments of aspects of the invention, a metering pump may be constructed and/or controlled as described above, in a chemical processing facility or a fluid dispenser. The variations described may be interchanged and combined in any suitable manner determined by one implementing an embodiment of the invention.

### BACKGROUND

The present invention relates to controlling fluid flow, for example using metering pumps, and particularly metering pumps including electronic controls.

Conventional metering pumps are positive displacement fluid pumps that displace a known, fixed volume of fluid each cycle or stroke of the pump. The mechanical design of such pumps is such that the volume of fluid displaced during each cycle or stroke of the pump is substantially independent of the rate at which the pump is operated, the pressure at the inlet to the pump, the back pressure at the outlet of the pump, and other operating parameters. Thus, when such pumps are used in chemical processes, drug or food delivery systems, etc., conventionally the pump is controlled so as to operate at a set cycle or stroke rate that when multiplied by the displacement volume of the pump provides a defined flow rate.

However, it has been found that while the foregoing is theoretically true, available pumps all have output volumes which vary with pressure at the inlet, back pressure at the outlet, cycle or stroke rate, and wear and tear. Thus, in order to obtain an accurate desired flow rate, at the time the pump is put into service, as well as periodically during the course of the service life of the pump, a draw down test under actual operating conditions must be performed in order to determine the actual flow rate provided by the pump. The cycle or stroke rate to which the pump control is set is then adjusted to accommodate these changes in the various parameters that effect such pump operation that have occurred.

### SUMMARY OF INVENTION

According to various aspects of embodiments of the invention, the actual flow rate produced by a metering pump is continuously measured using a positive displacement flow meter. Based on the flow rate reported by the meter, the output of the metering pump is continuously adjusted via a pump controller to achieve a desired set point flow rate. The operator sets a desired flow rate, rather than setting the pump cycle rate, or the output rating per pump cycle to produce an approximate output flow rate.

According to some embodiments of aspects of the invention, a fluid feed system commanded to a fluid flow rate set point by a set point signal includes: a metering pump receiving a control signal directing a cycle rate for the metering pump; a fluid flow meter connected to measure a fluid flow rate produced by the metering pump and which provides a fluid flow rate signal; and a metering pump controller responsive to the set point signal and the fluid flow rate signal to adjust the control signal to direct a cycle rate which produces a fluid flow rate equal to the fluid flow rate set point. In some variations on these embodiments, the metering pump is a positive displacement pump. In further variations, the metering pump controller determines the control signal based on a remote set point signal and the fluid flow rate signal. The fluid flow meter may be a positive displacement meter. In such cases, the positive displacement meter may be an oval gear meter.

According to other embodiments of aspects of the invention, there is a method of controlling a fluid flow rate, comprising: displacing an approximately defined quantity of fluid into the flow at a rate determined by a control signal; measuring an actual flow rate; and adjusting the control signal to produce a rate of displacing the approximately defined quantity of fluid such that the actual flow rate matches a desired flow rate. The method may be practiced wherein the control signal includes a pulse instructing the displacement of the approximately defined quantity. In other variations, the method may further comprise computing a continuous analog voltage or current control signal to achieve the desired flow rate.

According to yet other embodiments of aspects of the invention, a metering pump may be constructed and/or controlled as described above, in a chemical processing facility or a fluid dispenser. The variations described may be interchanged and combined in any suitable manner determined by one implementing an embodiment of the invention.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic drawing of a metering pump system illustrating various aspects of embodiments of the invention; and

FIG. 2 is a plan view of a pump controller assembly illustrating aspects of embodiments of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “compromising,” or “having,” “containing,” “involving”, and variations thereof herein, is meant to encompass the items listed thereafter and equivalents thereof as well as additional items.

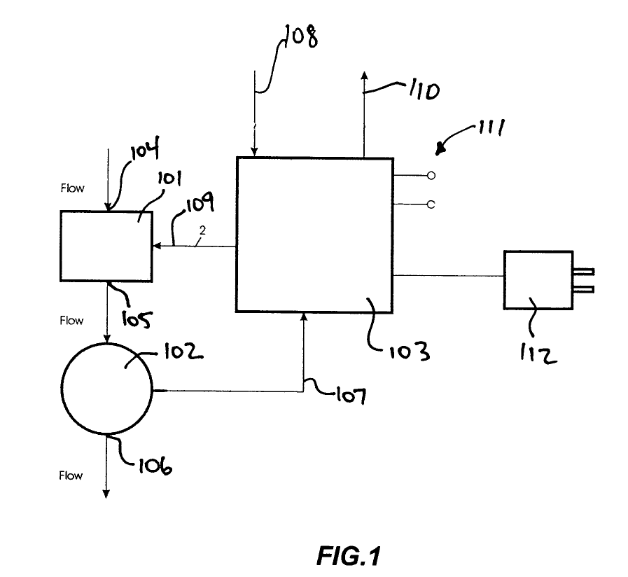

Referring now to FIG. 1, according to aspects of embodiments of the invention there are provided a metering pump 101, a positive displacement meter 102 and a flow controller 103. The metering pump has an input in communication with and receiving a fluid flow from a fluid feed stock (not shown), and has an output 105 in communication with and which passes the fluid flow to the positive displacement meter 102. Fluid flows through the meter 102 through outlet 106. The positive displacement meter 102 produces an output signal 107, for example an electronic signal, indicative of the total quantity of fluid which passes through meter 102. The output signal 107 indicative of the total quantity of fluid passing through the positive displacement meter 102 is communicated to the flow controller 103. Signal 107 can be communicated by wires, radio signals, inferred signals or any other suitable medium. Flow controller 103 also receives a feed rate set point signal 108. The flow controller 103 compares the feed rate set point signal 108 to the signal 107 indicative of the fluid flow rate and produces a control signal 109 which controls the cycle rate or number of strokes performed in a period of time by the metering pump 101.

Flow controller 103 can substantially continuously and proportionately control the flow output by metering pump 101 through its manipulations of control signal 109. Metering pump 101 may be configured to produce a single cycle or pump stroke for each pulse received on control signal 109. Any other suitable type of control signal communication medium and pump response can also be employed. For example, pump 101 can have a substantially continuous output whose rate is determined by a substantially continuous control signal 109.

Flow controller 103 compares the set point signal 108 to the flow meter output signal 107 to determine the correct value to which control signal 109 should be set. The comparison may be a simple difference, or it may be any other suitable computation including, for example, proportioning, derivatives, integrals, combinations of non-linear computations and the like, including but not limited to a Proportional-Integral-Derivative (PID) control.

Flow controller 103 may have a variety of input and output signal lines, as may be useful for various applications. The flow rate set point signal 108, for example, may be a 4-20 milliamp remote setting signal, as is conventionally used in this art. Flow controller 103 may have a 4-20 milliamp reported feed rate output signal 10, as is also in common in the art. Flow controller 103 may alternatively have a serial or parallel bus port for input and output of the flow rate set point, reported flow rates and program information for establishing the function and parameters to be used in performing the comparison between the flow rate set point and the reported flow rate from the positive displacement meter 102. In addition, flow controller 103 can report various alarm conditions, either using dedicated signal lines 111 or using a serial or parallel bus connected to a host computer. Power for the flow controller 103 may be provided by a wall transformer 112, a battery, or other suitable power source.

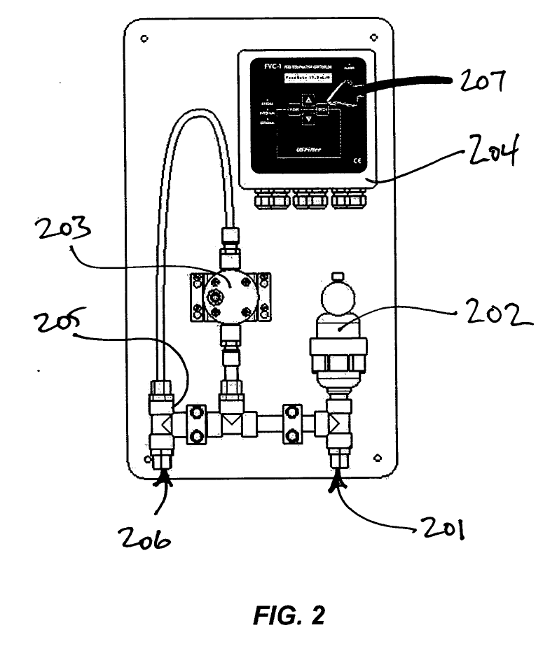

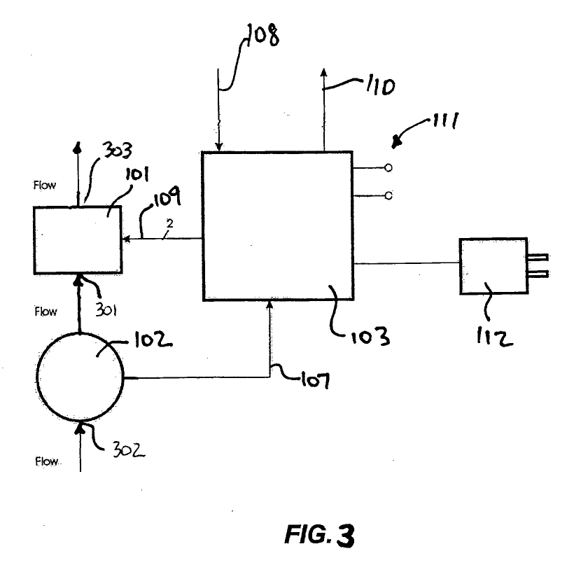

The component parts of a practical system, used for example in systems for addition of chemicals to drinking water, are now described in connection with FIG. 2. The metering pump output (FIG. 1, 105) is connected to inlet 201. A pulse dampener 202 smoothes out the flow produced by metering pump (FIG. 1, 101). Flow then continues through an oval gear sensor 203, one possible embodiment for positive displacement meter (FIG. 1, 102). Oval gear sensor 203 produces an output signal indicative of the total flow produced by metering pump (FIG. 1, 101), which is communicated to electronic controller 204. The fluid flow continues to flow through manifold assembly 205 to outlet 206. The flow set point signal (FIG. 1, 108) is provided to electronic controller 204 via a user interface including one or more keys 207. Keys 207 can be manipulated to set the flow set point, a timed draw down calibration, a low flow alarm set point, a high flow alarm set point, a deviation alarm set point for conditions which force the system to produce an output excessively far from the input set point, proportional control sensitivity, and calibration routines for calibrating the 4-20 milliamp input and output lines. Additional functions, inputs and outputs can be provided through the user interface.

An alternate embodiment to that shown in FIG. 1 is now described in connection with FIG. 3. According to this embodiment of aspects of the invention, the direction of fluid flow between the metering pump 101 and the positive displacement meter 102 is opposite the direction shown in FIG. 1. Thus, on the way to pump intake 301, fluid is received by meter intake 302 and passes through positive displacement meter 102. Fluid is discharged through pump output port 303. Controller 103 controls pump 101 in the same manner as described above in connection with FIG. 1. Since the fluid flow can be readily measured on either the intake or output side, the embodiments of FIGS. 1 and 3, in principle, operate the same way.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A fluid feed system commanded to a fluid flow rate set point by a set point signal, comprising:
a metering pump receiving a control signal directing a cycle rate for the metering pump;
a fluid flow meter connected to measure a fluid flow rate produced by the metering pump and which provided a fluid flow rate signal; and
a metering pump controller responsive to the set point signal and the fluid flow rate signal to adjust the control signal to direct a cycle rate which produces a fluid flow rate equal to the fluid flow rate set point.

2. The fluid feed system of claim 1, wherein the metering pump is a positive displacement pump.

3. The fluid feed system of claim 2, wherein the metering pump controller determines the control signal based on the set point signal and the fluid flow rate signal.

4. The fluid feed system of claim 1, wherein the fluid flow meter is a positive displacement meter.

5. The fluid feed system of claim 4, wherein the positive displacement meter is an oval gear meter.

6. A method of controlling a fluid flow rate, comprising:
displacing an approximately defined quantity of fluid at a rate determined by a control signal;
measuring an actual fluid flow rate; and
adjusting the control signal to produce a rate of displacing the approximately defined quantity of fluid such that the actual fluid flow rate matches a desired fluid flow rate.

7. The method of claim 6, wherein the control signal includes a pulse instructing the displacement of the approximately defined quantity.

8. The method of claim 6, further comprising:
computing an analog pump control signal to achieve a desired flow rate.

9. A chemical processing facility, comprising:
a fluid feedstock;
a metering pump receiving a control signal directing a cycle rate for the metering pump;
a fluid flow meter connected to measure a fluid flow rate produced by the metering pump and which provides a fluid flow rate signal;
a metering pump controller responsive to the set point signal and the fluid flow rate signal to adjust the control signal to direct a cycle rate which produces a fluid flow rate equal to the fluid flow rate set point; and
a process consuming fluid at a rate equal to the fluid flow rate set point.

10. The chemical processing facility of claim 9, wherein the metering pump is a positive displacement pump.

11. The chemical processing facility of claim 10, wherein the metering pump controller determines the control signal based on a remote set point signal and the fluid flow rate signal.

12. The chemical processing facility of claim 9, wherein the fluid flow meter is a positive displacement meter.

13. The chemical processing facility of claim 12, wherein the positive displacement meter is an oval gear meter.

14. A fluid dispenser, comprising:
a fluid feedstock;
a metering pump receiving a control signal directing a cycle rate for the metering pump;
a fluid flow meter connected to measure a fluid flow rate produced by the metering pump and which provides a fluid flow rate signal;
a metering pump controller responsive to the set point signal and the fluid flow rate signal to adjust the control signal to direct a cycle rate which produces a fluid flow rate equal to the fluid flow rate set point; and
a fluid outlet through which the fluid flow produced by the metering pump is communicated.

15. The fluid dispenser of claim 14, wherein the metering pump is a positive displacement pump.

16. The fluid dispenser of claim 15, wherein the metering pump controller determines the control signal based on the set point signal and the fluid flow rate signal.

17. The fluid dispenser of claim 14, wherein the fluid flow meter is a positive displacement meter.

18. The fluid dispenser of claim 17, wherein the positive displacement meter is an oval gear meter.
